(19) United States
(12) Patent Application Publication
(10) Pub. No.: US 2022/0186647 A1
(43) Pub. Date: Jun. 16, 2022

(54) HEATING DEVICE FOR AN EXHAUST SYSTEM AND AN EXHAUST SYSTEM

(71) Applicant: Faurecia Emissions Control Technologies, Germany GmbH, Augsburg (DE)

(72) Inventors: David Saurat, Augsburg (DE); Yannick Fourcaudot, Bavans (FR); Christophe Basso, Bavans (FR); Jean-Francois Perret, Bavans (FR); Jura Kautz, Augsburg (DE); Claudia Herbers, Augsburg (DE); Jörg Veittinger, Augsburg (DE); Matthias Mallon, Augsburg (DE)

(21) Appl. No.: 17/537,602

(22) Filed: Nov. 30, 2021

(30) Foreign Application Priority Data
Nov. 30, 2020 (DE) 10 2020 131 694.1
May 12, 2021 (DE) 20 2021 102 620.0

(51) Int. Cl. F01N 3/20; B01D 46/00; B01D 46/84; B01D 53/94; F01N 3/027; F01N 3/28

(52) U.S. Cl. CPC F01N 3/2013; B01D 46/0027; B01D 46/84; F01N 2510/06; F01N 3/027; F01N 3/2803; F01N 2240/16; B01D 53/94

(57) ABSTRACT

A heating device for an exhaust system has an electrically conductive foamed part and at least one stabilization part for the foamed part. The foamed part includes two end faces, an outer circumference and at least one recess starting from the outer circumference and extending in the axial direction from one to the other end face. The recesses produce sections which are opposite each other at a distance and continue into each other, forming a current path as a resistance heating element. The stabilization part at least partially fills the recess and mechanically couples the sections to each other, but does not electrically couple them to each other.

The invention relates to a heating device for an exhaust system and an exhaust system with a heating device.

Exhaust systems of internal combustion engines usually include catalytic converters to reduce emissions.

In order for catalytic oxidation to proceed in an optimum manner immediately after a cold start, it is known to provide heating devices that heat the catalytic converter to a reaction temperature. The so-called light-off temperature describes the threshold value as from which a catalytic reaction can take place and conversion of harmful emissions begins.

Furthermore, a heating device through which exhaust gas flows may be provided, which is arranged upstream of the catalytic converter and is configured to heat the exhaust gas before it flows through the catalytic converter.

It is already known here to provide heating grids or heating wires for heating.

However, installation and mounting of such heating devices in exhaust systems is generally complicated. In addition, such heating devices are subjected to high loads during operation due to large temperature fluctuations and vibrations, which does not allow a conventional heating device from the prior art to be used for specific applications or has an adverse effect on the service life of the heating device.

It is therefore an object of the present invention to provide a heating device for an exhaust system which is particularly simple to manufacture and install and which can withstand the stresses existing in the exhaust system.

The object is achieved according to the invention by a heating device for an exhaust system, in particular of a motor vehicle, including an electrically conductive foamed part which is coupled to at least one electrode, and at least one stabilization part for the foamed part. The foamed part, more precisely its upstream end face, is oriented transversely (i.e. orthogonally or obliquely, e.g. at an angle of up to 45°) to an exhaust gas stream, the exhaust gas to be treated can flow axially through it, and it includes an upstream oriented front end face, a downstream oriented rear end face, an outer circumference and at least one recess starting from the outer circumference and extending through the foamed part in the axial direction from the front end face to the rear end face. The recesses produce sections of the foamed part which are opposite each other at a distance and continue into each other, forming a current path as a resistance heating element between the at least one electrode and a further electrically conductive component, in particular a further electrode, to which the foamed part is coupled. The stabilization part at least partially fills the recess and mechanically couples the sections to each other, but does not electrically couple them to each other. The stabilization part may be dielectric.

In the context of the invention, axial direction means an axial direction relating to the heating device and/or to the foamed part and substantially parallel to a main flow direction of the exhaust gas to be treated. Accordingly, a central axis (normal) of the heating device and/or of the foamed part extending in the axial direction is substantially parallel to the main flow direction.

In the context of the invention, a transverse direction means a direction of the front end face of the foamed part that is orthogonal or oblique, i.e. at an angle of preferably up to 45°, to the axial direction. The transverse direction thus includes a radial direction.

The core of the invention therefore is an electrically conductive foamed part which is very simple to manufacture and which, owing to the recesses, constitutes a current path which, when a current is applied to the at least one electrode and the further electrically conductive part, will heat the foamed part and consequently the gas to be treated. However, due to the recesses, the inherent stiffness of the foamed part is reduced, which is unfavorable. By coupling the foamed part to at least one stabilization part, the sections that are spaced apart from each other by the recess are mechanically coupled to each other, as a result of which, in particular, axial and/or radial movements of the sections can be prevented, which are caused, for example, by the gas flow or by vehicle or engine vibrations. This allows in particular the axial and/or radial stiffness of the heating device to be significantly increased.

The at least one stabilization part mainly stabilizes the sections relative to each other. The stabilization part here may rest against the foamed part over a cross-sectional area and thereby stabilize it axially and/or radially. In addition, the invention allows an at least partial decoupling from electrical dependent variables and mechanical properties of the foamed part.

Optionally, the at least one stabilization part may contribute indirectly or directly to an axial mounting or support.

Within the scope of this invention, a distinction between the term “stabilization” and the term “holder/support” is of major importance. Stabilization refers to an increase in the stiffness of the heating device. The stabilization of the foamed part is implemented by coupling it to the stabilization part, which reduces the load on the heating device as caused by vibration excitations as well as by other mechanical loads, such as gas pulsations, gas flow-through and/or temperature expansions. The aim is to support the heater tracks (sections) that form the current path to the effect that the heating device permanently withstands the typical loads in the exhaust gas flow. In contrast, the holder or support describes an attachment of the heating device in the gas line or an axial resting of the heating device against a part fastened to the gas line.

To ensure electrical conductivity and, consequently, heating of the foamed part by an electric current flow, the foamed part may be coated with or consist of an electrically conductive material, e.g., be a metal foam.

Optionally, the foamed part (i.e. the first foamed part and/or the stabilization part) may additionally comprise a catalytic material. In this way, a catalytic function can also be obtained in addition to the heating function. In this case, the foamed part also constitutes an electrically heated catalyst (EHC).

To avoid electrical bypasses or electrical short circuits, the at least one stabilization part may be electrically insulating, at least in the region of the surfaces in contact with the foamed part.

To this end, the at least one stabilization part may include an electrically insulating coating, for example a ceramic coating.

Alternatively or additionally, the at least one stabilization part may be made of an electrically insulating material, in particular constitute a dielectric.

According to one aspect, the at least one recess, in an axial view, extends between the sections in a straight line and/or in a curved manner, in particular wherein the current path extends in a spiral shape or a meandering shape. The at least one recess specifies a path of the electric current through the foamed part. The current path defined in this way is significantly extended in comparison to the current path of a foamed part without recesses, which results in a higher heating power and thus in a uniform heating of the foamed part and, consequently, of the exhaust gas to be treated.

A further aspect provides that the foamed part includes a plurality of recesses that extend parallel at least in sections when viewed axially, in particular wherein neighboring recesses begin at substantially opposite portions of the outer circumference and extend between neighboring recesses that start from the opposite portion. In this way, the current path can be greatly extended, and thereby a particularly uniform heating of the foamed part can be achieved.

In one variant of the invention, linear stabilizing tines, similar to tines of a rake, each extend from opposing sections of the outer circumference to the respectively opposing section, so that the rakes engage each other.

One embodiment provides that the at least one stabilization part rests against the front end face and the rear end face, extends axially through the recess, and clamps the foamed part between face side contact surfaces of the stabilization part. As a result, the opposing sections of the foamed part, which are separated by the recess, are fastened to each other, which also results in an axial and/or radial stabilization of the foamed part.

Alternatively or additionally, the at least one stabilization part is attached to inner walls of the foamed part that bound the recess, and thereby mechanically couples the adjacent sections. This attachment may be effected, e.g., by gluing, which, however, is not limiting.

Provision may be made here that the stabilization part does not rest on any of the end faces or extends up to them. This provides a larger cross-sectional area for gas to flow through and be heated.

In particular, the axial extent of the at least one stabilization part substantially corresponds to the axial extent, i.e. the thickness, of the foamed part. This allows the heating device to be designed to be particularly compact.

A support frame may be provided which circumferentially surrounds the foamed part at the outer circumference, in particular wherein the support frame rests against an outer circumferential surface and/or against at least one of the end faces. The support frame further stabilizes the foamed part and, in addition, the foamed part can be fastened in the exhaust pipe via the support frame. Preferably, the support frame rests against an outer circumferential surface and/or against at least one of the end faces so as to be electrically insulated.

Optionally, the support frame may also be used to mount other components, for example a (foamed) catalytic converter. In this way, there is no need to provide a separate support device for the further component, which reduces the number of components and thus the necessary installation space.

In particular, the support frame is formed in one piece. This ensures simple manufacture.

Alternatively, the support frame may also be formed in several parts, which may be of advantage when the heating device is installed.

The support frame predominantly has a supporting or holding function. Stabilization of the foamed part in the flow-through area is of less relevance here.

A further embodiment provides that the at least one stabilization part is fastened to the support frame and, starting from the support frame, extends in the transverse direction into the at least one recess, and the at least one stabilization part is adapted to the shape of the at least one recess, in particular in that it completely fills the at least one recess by the at least one stabilization part. By attaching the stabilization part to the support frame, a particularly stable heating device can be provided. In addition, the foamed part can be fastened in the gas pipe by means of the at least one stabilization part and the support frame.

In particular, all recesses are completely filled. In this way, a particularly stable heating device can be provided, because the recesses do not now weaken the stabilization part.

For example, the foamed part is molded, foamed or injected into the intermediate space between the at least one stabilization part and the support frame, or the at least one stabilization part and the support frame are molded, foamed or injected into the recesses and around the outer circumference. In this way, the heating device can be manufactured particularly simply and cost-effectively, requiring very few components, and at the same time a particularly reliable mechanical or even inter-material coupling can be established between the foamed part and the stabilization part and the support frame.

The stabilization of the foamed part can be effected herein, as mentioned, by an inter-material attachment of the foamed part to the at least one stabilization part and/or to the support frame.

Optionally, the support frame has a plurality of parts coupled to one another, which rest against the end faces and between which the foamed part is clamped, the parts being electrically non-conductive at least in their regions contacting the end faces in order to avoid short-circuit currents.

In particular, the coupled parts extend along the outer circumference and clamp the foamed part in the region of the outer circumference.

Alternatively, there is a frame part on one end face and separate parts at the opposite end face, which are fixed with the frame part. The foamed part is clamped between the frame part and the separate parts. Here, the areas coming into contact with the end faces are electrically non-conductive.

In particular, the stabilization parts are formed to be pin-like. The pin-like configuration of the stabilization parts, which is optimized in terms of installation space, allows the stabilization parts to be selectively arranged at stabilization-critical points of the foamed part, which have been determined, for example, by simulations. This allows a stabilization of the foamed part to be achieved that is optimized in terms of installation space and components.

For example, the stabilization part has a laterally projecting head part at one of its two axial ends and a counter piece at the opposite end. The foamed part is clamped between the head part and the counter piece. The head parts and the counter pieces allow a larger area of contact to be provided with the foamed part, as a result of which the clamping force acting on the foamed part at certain points can be distributed over a larger area. In this way, damage to the foamed part caused by the stabilization part can be reduced or prevented. Furthermore, the sections spaced apart from each other are mechanically coupled in the axial direction.

Preferably, a respective electrically insulating element is provided at each of the ends of the stabilization part, wherein the electrically insulating elements rest against the foamed part on opposite sides and the foamed part is clamped between the electrically insulating elements by the stabilization part, wherein the clamping force is adjusted by the distance between the head part and the counter piece, and wherein the materials of the stabilization part, the electrically insulating elements and the foamed part are selected based on their coefficients of thermal expansion such that in the case of any temperature change within an operating temperature range of −50° C. to 1100° C., neither the foamed part is plastically deformed nor does the clamping force decrease to zero. In this way, the foamed part is both reliably held during operation and not clamped too hard, so that no plastic deformation takes place during operation. Since plastic deformation does not occur at any temperature fluctuations within the operating temperature range, the foamed part is able to spring back again after any temperature fluctuations within the operating temperature range, so that a clamping force greater than zero is ensured for future temperature changes.

According to one embodiment, at least some of the electrically insulating elements include a collar resting on one side of the foamed part and an extension that extends into the recess. The supported collar provides an electrical insulation between the shank of the pin and the foamed part. The extension allows insulation between the foamed part and the longitudinal part of the compensating element.

Owing to the collar and the extension of the insulating element, electrical short circuits between the opposing sections of the recesses in the foamed part are avoided.

Advantageously, at least one of the electrically insulating elements has a front side surface and a through hole that extends from the front side surface. The through hole increases in size along its longitudinal direction toward the front side surface. In particular, the increase in size of the through hole is formed by a transition surface extending obliquely to the front side surface, and the head part or a cap of the counter piece rests on this transition surface. This allows the effective length of the stabilizing part to be reduced, as a result of which different coefficients of expansion of the insulating elements, the foamed part and the pin have less effect on the clamping force.

Preferably, an additional elastic compensating element is arranged and clamped between an electrically insulating element and the contacting head part or counter piece. This compensating element provides the advantage that different coefficients of expansion in the insulating elements, the foamed part and the stabilizing part can be compensated for and the clamping force thus remains approximately the same at different temperatures within the operating temperature range.

According to a further variant, the elastic compensating element is a spring element or an elastic mat. While the use of a spring element can reduce the variety of parts by allowing the counter piece, which is formed from a cap and the contacting elastic compensating element, to be formed in one piece, use of the elastic mat allows a particularly compact design.

Moreover, an additional electrically insulating sleeve may be arranged between a shank of the stabilization part and the foamed part in the recess, whereby the foamed part is held at a defined distance from the shank by this sleeve. As a result, the foamed part is held in position not only by the clamping force, but additionally by the sleeve, which at least partly encloses the shank. This entails a better mechanical connection of the foamed part to the stabilization part and prevents slipping of the foamed part during operation, thus ensuring electrical insulation.

In a further embodiment, the foamed part is reinforced with a bushing, which is embedded in the foamed part, between the two electrically insulating elements in the area of the recess. This bushing is more robust than the foamed part, so that an unwanted plastic deformation during operation does not occur until the clamping force increases significantly. This gives the advantage of allowing a greater difference in linear expansion between the insulating elements, the foamed part and the pin in operation, and thus a larger choice of materials to be considered.

Advantageously, the bushing is made to be slotted and/or comprises both electrically insulating and non-insulating materials. Electrically non-insulating materials such as metals exhibit very good resistance to plastic deformation, resulting in a higher critical clamping force at which plastic deformation occurs. This also provides the advantage of a wider choice of eligible materials for the pin, the electrically insulating elements and the foamed part. The slotted bushings formed with non-conductive materials prevent short-circuiting of the opposing portions of a recess.

According to a further variant, in the state not provided with the stabilization part, the foamed part is plastically deformed locally at its axial contact surfaces for the two electrically insulating elements, forming a depression into which the associated electrically insulating element extends. This plastic pre-deformation strengthens and consolidates the foamed part between the axial contact surfaces, which means that progression of this plastic deformation in operation only occurs under high load. As with the use of a bushing, this measure entails the advantage of a wider choice of materials to be considered for the pin, the electrically insulating elements and the foamed part.

Preferably, a plurality of stabilization parts are provided in a recess, which makes a uniformly distributed load absorption by the stabilization parts possible. This is of importance in particular in operation, where an additional load occurs due to the gas flow. Furthermore, the spaced-apart sections may be stabilized at several points.

The object is further achieved according to the invention by an exhaust system which includes an exhaust gas-carrying pipe and a heating device according to the invention which is seated in the pipe and through which exhaust gas flows, wherein a support frame is provided which circumferentially surrounds the foamed part on the outer circumference, and wherein the foamed part is completely self-supporting in the axial direction, either in itself or in cooperation with the stabilization parts, in the region laterally of the support frame. Owing to the self-supporting property of the foamed part, which is achieved for example by the stabilization parts, it is not necessary for a grid-shaped support part to be additionally installed axially spaced apart from the foamed part. Thus, no further part needs to extend over the foamed part in order to achieve a support of the foamed part in the axial direction. This saves installation space and components.

The above-described advantages and features of the exhaust system according to the invention apply equally to the heating device, and vice versa.

Further advantages and features of the invention will be apparent from the description below and from the accompanying drawings, to which reference is made and in which:

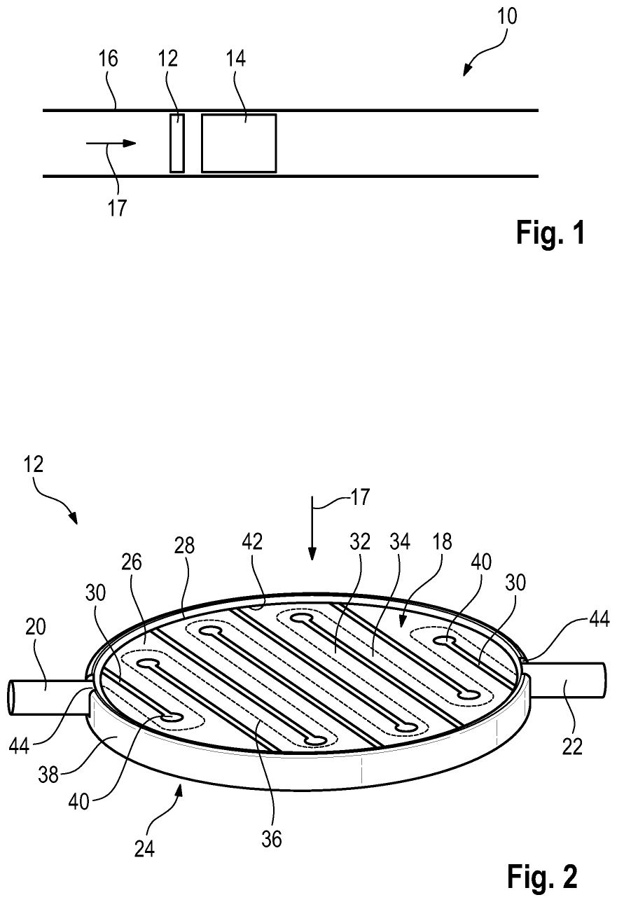

FIG. 1 schematically shows an exhaust system according to the invention with a heating device according to the invention;

FIG. 2 shows a perspective view of a first embodiment of the heating device according to the invention as shown in FIG. 1;

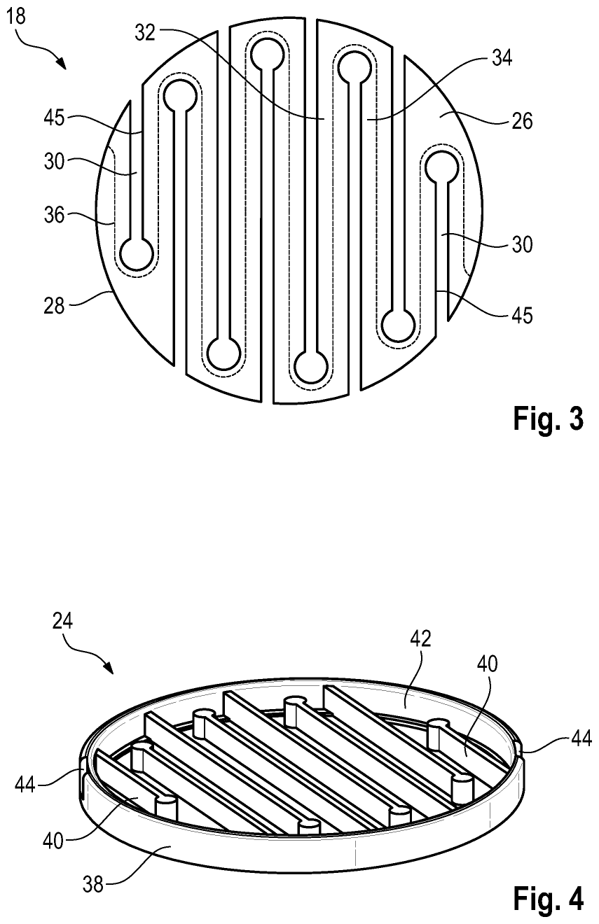

FIG. 3 shows a top view of a foamed part of the heating device according to the first embodiment of the invention as shown in FIG. 2;

FIG. 4 shows the perspective view of the first embodiment of the heating device according to the invention as shown in FIG. 2, without the foamed part;

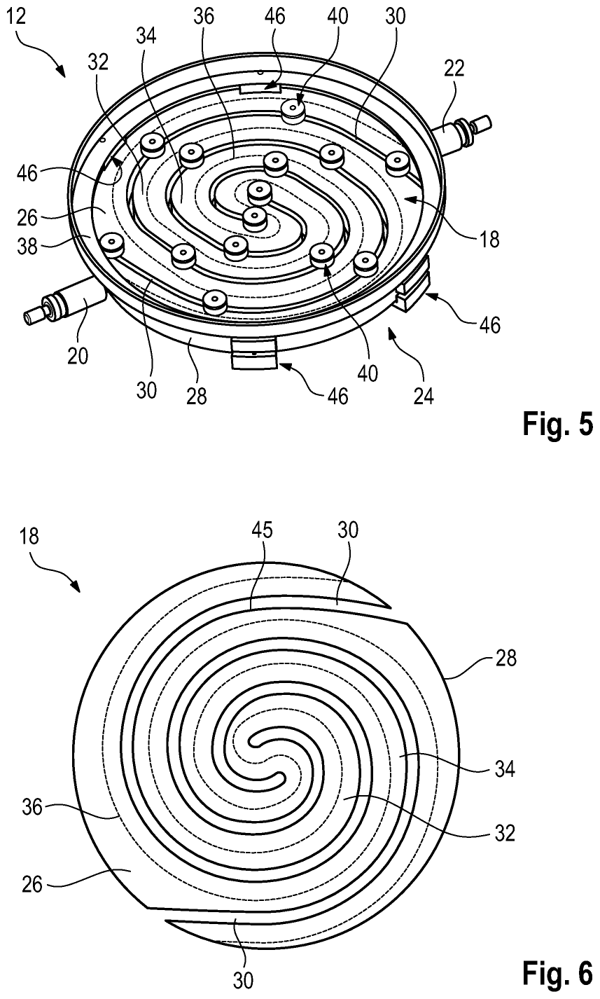

FIG. 5 shows a perspective view of a second embodiment of the heating device according to the invention as shown in FIG. 1;

FIG. 6 shows a top view of a foamed part of the heating device according to the second embodiment of the invention as shown in FIG. 5;

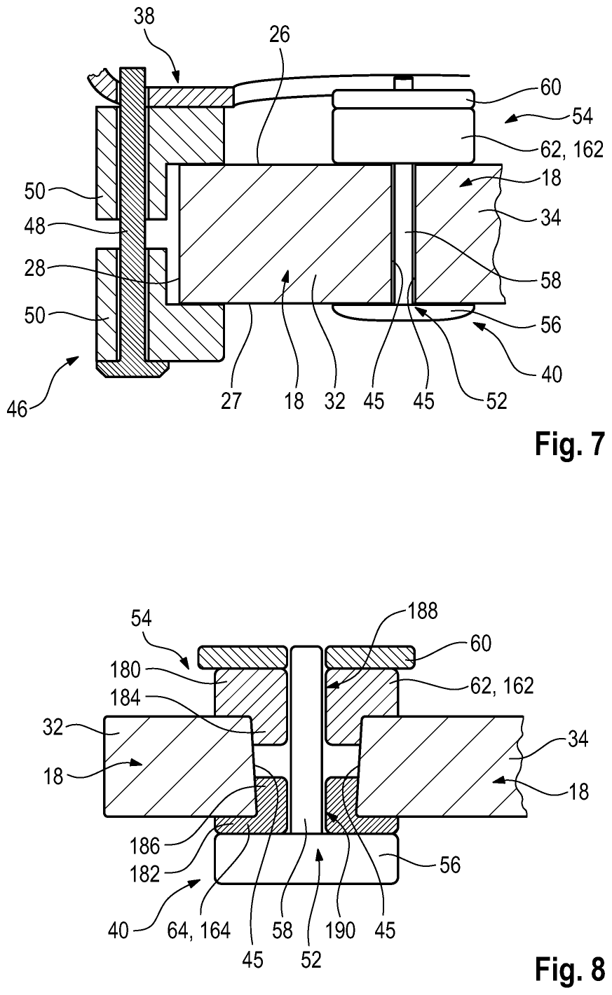

FIG. 7 shows an axial section of an area of the heating device according to the second embodiment of the invention as shown in FIGS. 5 and 6, which illustrates, inter alia, a first variant of a pin-like stabilization part;

FIG. 8 shows an axial section of a second variant of the pin-like stabilization part;

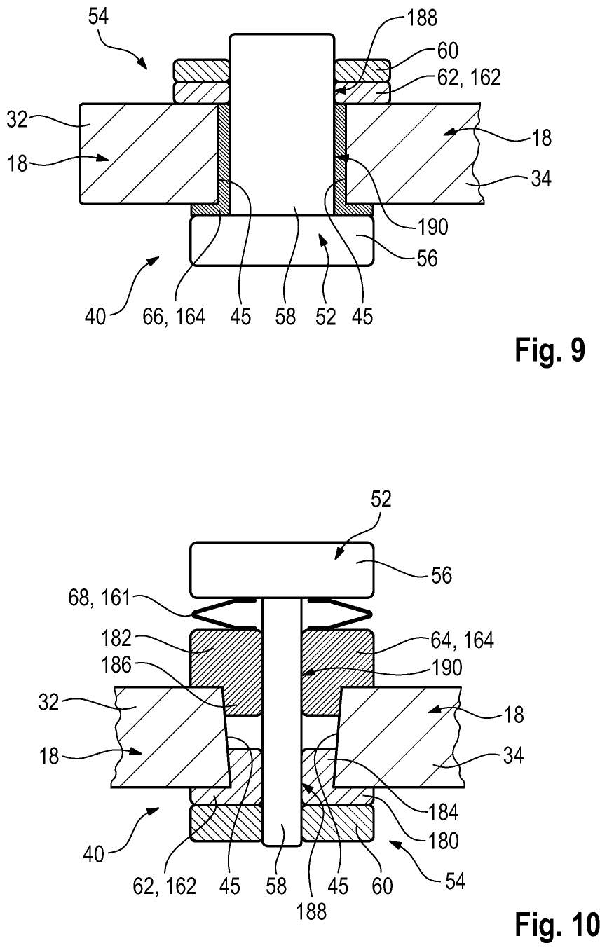

FIG. 9 shows an axial section of a third variant of the pin-like stabilization part according to FIGS. 5 to 7;

FIG. 10 shows an axial section of a fourth variant of the stabilization part;

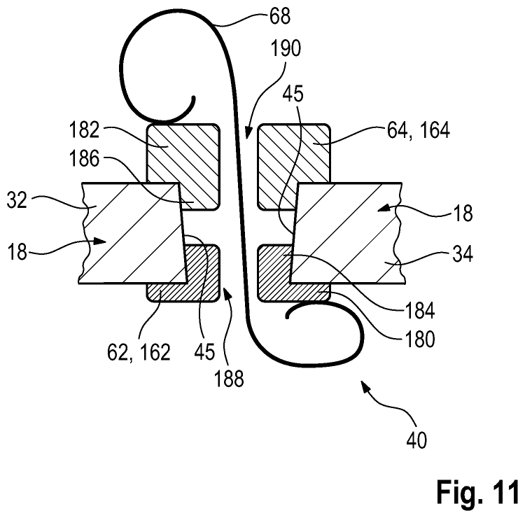

FIG. 11 shows an axial section of a fifth variant of the pin-like stabilization part;

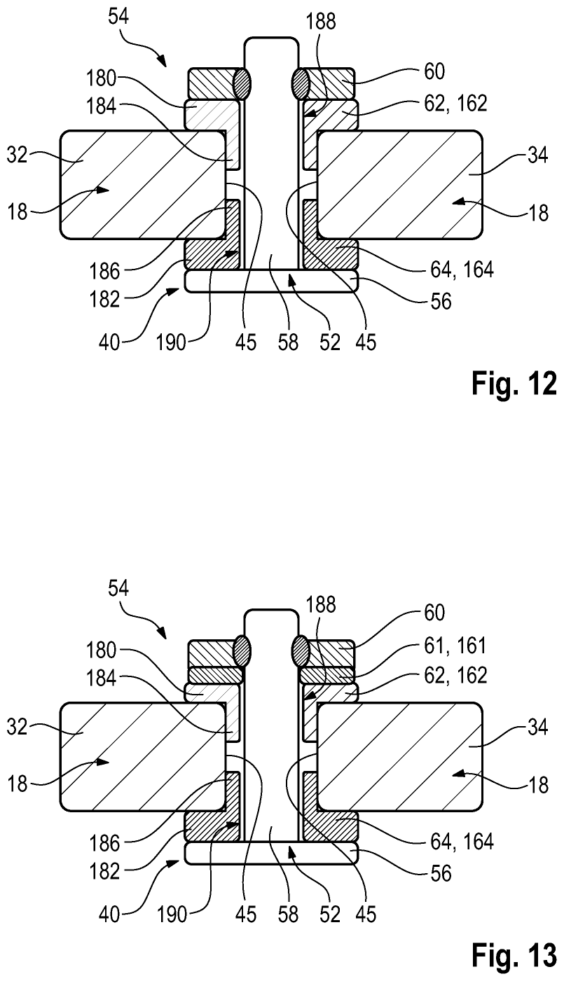

FIG. 12 shows an axial section of a further variant of the pin-like stabilization part;

FIG. 13 shows an axial section of a further variant of the pin-like stabilization part;

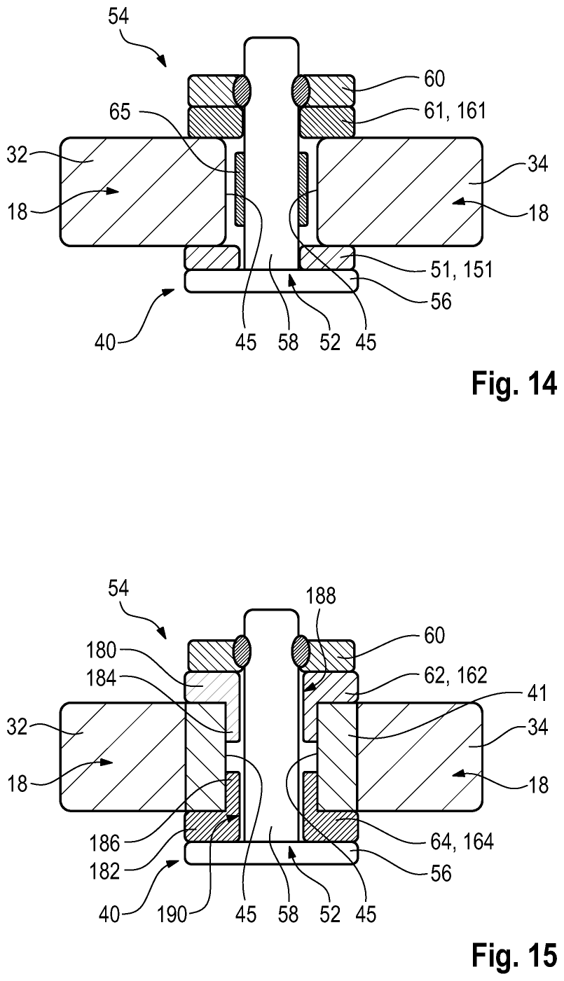

FIG. 14 shows an axial section of a further variant of the pin-like stabilization part;

FIG. 15 shows an axial section of a further variant of the pin-like stabilization part;

FIG. 16 shows an axial section of a further variant of the pin-like stabilization part;

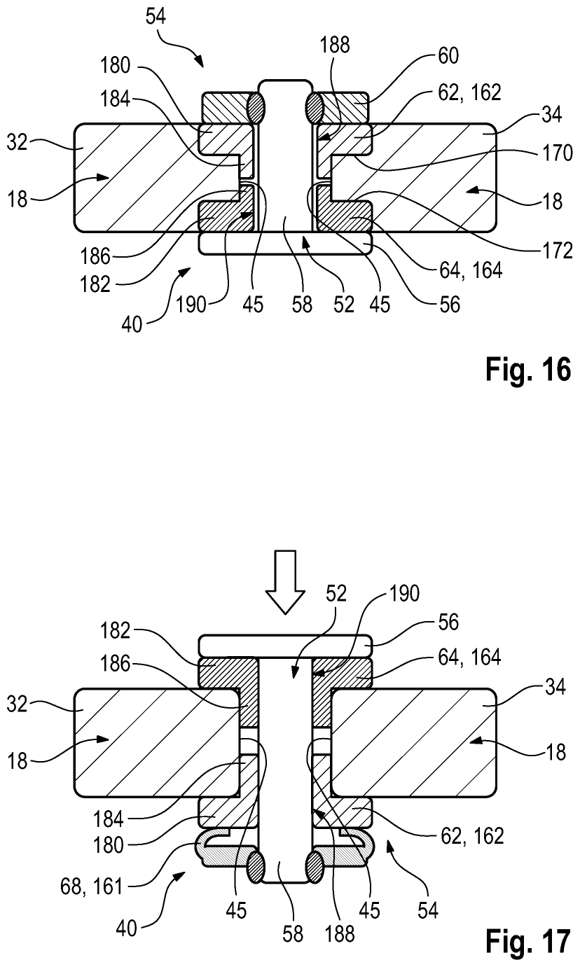

FIG. 17 shows an axial section of a further variant of the pin-like stabilization part;

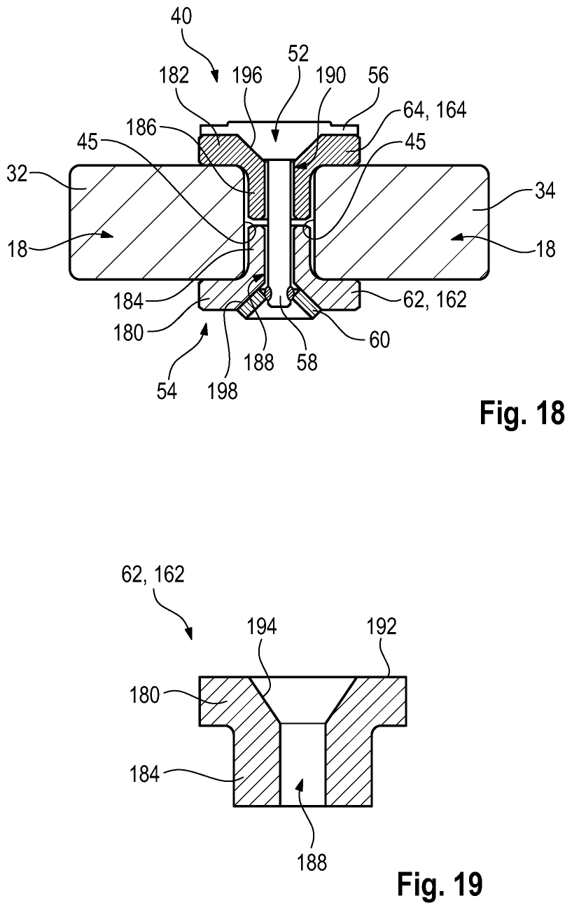

FIG. 18 shows an axial section of a further variant of the pin-like stabilization part; and

FIG. 19 shows an axial section of a first insulating sleeve of the stabilization part as shown in FIG. 18.

FIG. 1 schematically illustrates an exhaust system 10 of a vehicle comprising a heating device 12 and a catalytic converter 14.

The heating device 12 and the catalytic converter 14 are arranged within an exhaust gas-carrying pipe 16 of the exhaust system 10 such that exhaust gas flows through both the heating device 12 and the catalytic converter 14.

The main flow direction 17 (axial flow direction) of the exhaust gas is depicted in simplified form by an arrow.

The heating device 12 is arranged upstream of the catalytic converter 14 so that the heating device 12 can heat the exhaust gas before it flows through the catalytic converter 14. This improves catalytic oxidation immediately after a cold start, and emissions are reduced since the catalytic converter 14 is heated up quickly.

FIG. 1 illustrates the heating device 12 and the catalytic converter 14 separately from each other. This should be understood only as an example since in one embodiment the catalytic converter 14 may be integrated in the heating device 12, as will be described in more detail further below.

FIG. 2 shows a first embodiment of the heating device 12 in more detail.

The heating device 12 comprises an electrically conductive foamed part 18 which is electrically connected by diametrically opposed electrodes 20, 22, and a stabilization and support device 24.

The part 18 extends transversely (i.e. orthogonally or obliquely) to the main flow direction 17.

In the present case, the further electrical component which is present in addition to one of the electrodes 20, 22 is thus formed by the other of the two electrodes 20, 22.

The foamed part 18 may have an electrically conductive coating or may consist of an electrically conductive material, e.g., metal.

Optionally, the foamed part 18 may additionally comprise a catalytic material, for example be coated therewith, which provides the heating device 12 with a catalytic function in addition to the heating function. A heating device 12 of this type thus constitutes an electrically heated catalyst (EHC).

The foamed part 18 is made of a gas-permeable material to allow the exhaust gas to flow through the heating device 12.

With additional reference to FIGS. 3 and 4, the properties of the foamed part 18 and the stabilization and/or support device 24 will be described below.

In the embodiment illustrated here, the foamed part 18 is configured to be disk-shaped and has an upstream oriented front end face 26, a downstream oriented rear end face 27, and an outer circumference 28.

Furthermore, the foamed part 18 has a plurality of recesses 30 which extend through the foamed part 18 in the axial direction from the front end face 26 to the rear end face and, as viewed in the axial direction, in the embodiment illustrated here extend from the outer circumference 28 in a straight line into the foamed part 18.

In this embodiment, the recesses 30 run parallel to each other, with neighboring recesses 30 beginning at substantially opposite portions of the outer circumference 28 and extending between neighboring recesses 30, which start from the opposite portion, like tines of rakes that engage each other.

Two respective opposing sections 32, 34 are formed by the recesses 30, which are spaced apart from each other by the associated recess 30.

In other words, the recesses 30 terminate freely within the inner region, bounded by the outer circumference 28, of the foamed part 18.

In this way, the foamed part 18 is not divided into completely separate parts by the recesses 30.

The sections 32, 34 thus continue into each other in the region of the free end of the recesses 30.

The recesses 30 thus define a shape of the foamed part 18 which predefines a specific current path 36 that is illustrated in a simplified manner as a dashed line in FIGS. 2 and 3. Owing to the arrangement of the recesses 30 as shown here, the current path runs in a meandering or serpentine fashion.

Compared to a foamed part 18 without recesses 30, the current path 36 is significantly extended by means of the recesses 30, which results in a longer resistance heating element and thus in a more uniform and stronger heating of the foamed part 18.

FIG. 4 illustrates the stabilization and/or support device 24, which comprises a support frame 38 shaped as a ring, e.g., a multi-part support frame 38, and a plurality of stabilization parts 40 projecting from the support frame 38 in a finger-like manner into an interior area of the support frame 38.

In detail, the stabilization parts 40 have one end attached to or integrally molded with an inner circumferential surface 42 of the support frame 38 and extend in a straight line in the transverse direction close to an opposite portion of the support frame 38. A distance is provided between the opposite portion of the support frame 38 and a free end of each of the stabilization members 40.

Recesses or openings 44 for the electrodes 20, 22 may be provided in the support frame 38.

The stabilization parts 40 may be separate from the support frame 38 and be fastened to the support frame 38 by welding or other connecting methods.

As an alternative, and as shown in this embodiment, the stabilization members 40 may integrally transition into the support frame 38.

As can be seen in FIG. 2, the support frame 38 circumferentially surrounds the outer circumference 28 of the foamed part 18, with the inner circumferential surface 42 of the support frame 38 resting against an outer circumferential surface of the foamed part 18. The stabilization parts 40 extend into the recesses 30 of the foamed part 18.

In the embodiment illustrated here, the stabilization parts 40 are adapted to the shape of the recesses 30, with the stabilization parts 40 completely filling the recesses 30. That is, the stabilization parts 40 rest continuously and completely against walls 45 defining the recesses 30 (cf. FIG. 3).

This is achieved in that the foamed part 18 is molded, foamed or injected into the intermediate space between the stabilization parts 40 and the support frame 38, or the stabilization parts 40 and the support frame 38 are molded, foamed or injected into the recesses 30 and around the foamed part 18.

However, this should be understood only as an example. Provision may also be made for the foamed part 18 and the stabilization and/or support device 24 to be manufactured separately from each other and attached to each other by any one of many commonly used connection methods.

Furthermore, not all of the recesses 30 necessarily need to be completely filled, but only selected ones of the recesses 30 may be completely filled, or all of the recesses 30 or only specific recesses 30 may also be only partially filled to allow exhaust gas to flow through the non-filled areas.

The stabilization parts 40 and the support frame 38 are formed of a non-conductive or an electrically insulating material, or have a non-conductive or an electrically insulating coating at least in the areas of contact with the foamed part 18. In this way, an electrical bypass or an electrical short circuit between the sections 32, 34 is avoided and thus the current path 36 predefined by the recesses 30 of the foamed part 18 is maintained.

This means that the stabilization parts 40 can ensure that the sections 32, 34 remain spaced apart from each other and do not touch each other even in the event of movements of the foamed part 18, for example caused by the gas flow or by vehicle vibrations.

The recesses 30 cause the foamed part 18 to be relatively unstable and easily deformable, above all in the axial and/or radial direction, which may lead to damage and reduced service life under moving ambient conditions, e.g. vibrations in a traveling motor vehicle. The stabilization parts 40 and the support frame 38 mechanically couple the opposing sections 32, 34 to each other so that, above all, relative axial and/or radial movement is prevented. This means that the sections 32, 34 cannot move relative to each other because they are fixed to the stabilization parts 40 and the support frame 38.

In addition to the stabilization of the foamed part 18, the foamed part 18 is fastened in the gas pipe 16 by means of the support frame 38.

The electrically non-conductive configuration of the support frame 38 provides an electrical insulation of the heating device 12 from the gas pipe 16.

FIGS. 5 to 7 illustrate a second embodiment of the heating device 12, which is substantially similar to the first embodiment of the heating device 12 shown in FIGS. 2 to 4. Accordingly, only the differences will be discussed below, and identical and functionally identical parts are indicated by the same reference numbers.

Rather than straight-line recesses 30, the foamed part 18 according to the second embodiment has recesses 30 that extend from the outer circumference 28 in a spiral pattern into a central region of the foamed part 18. Here, the recesses 30 start at substantially opposite portions of the outer circumference 28.

This provides a current path 36 that has two parts extending in the same direction and spirally with respect to each other, with the spirals running into each other.

Further, the support frame 38 does not rest against the outer circumferential surface of the foamed part 18, but is arranged at the front end face 26.

Of course, the support frame 38 may also be arranged at the rear end face.

Furthermore, the support frame 38 may also be composed of a plurality of frames, one of which rests against the outer circumferential surface of the foamed part 18 as in the first embodiment, and the other of which is arranged on one of the end faces according to the second embodiment. Here, for example, the frame arranged at the end face may be fastened to the other frame.

Here, the support frame 38 engages the foamed part 18 by means of a plurality of fastening devices 46 resting against the outer circumferential surface of the foamed part 18.

In contrast to the first embodiment, in the second embodiment a plurality of separate stabilization parts 40 are provided in a recess 30, which only partially fill the respective recess 30. The stabilization parts 40 are not coupled to the support frame 38.

One of the fastening devices 46 and one of the stabilization parts 40 are shown in more detail in FIG. 7.

The fastening device 46 comprises a plurality of parts coupled to each other, namely a fastening pin 48 and two clamping parts 50.

One of the clamping parts 50 rests against the front end face 26 of the foamed part 18 and the other of the clamping parts 50 rests against the rear end face 27, so that the foamed part 18 is clamped between the two clamping parts 50.

The clamping force is generated by the fastening pin 48, which extends through the clamping parts 50 laterally of the outer circumference 28 in the axial direction and is screwed into the support frame 38, urging the clamping parts 50 against the foamed part 18 and the support frame 38.

In the variant illustrated here, the clamping parts 50 comprise an electrically insulating material, for example ceramics, at least in the area of contact with the foamed part 18, the support frame 38 and the fastening pin 48.

To this end, the clamping parts 50 may be coated with or consist of the electrically insulating material.

In this case, the support frame 38 and the fastening pin 48 may be made from an electrically conductive material, since the fastening pin 48 and the support frame 38 are spaced apart from the foamed part 18 by the clamping parts 50, and the foamed part 18 is electrically insulated from the support frame 38 and the fastening pin 48.

In a different case, in which the fastening pin 48 and the support frame 38 comprise electrically insulating material at least in the area of contact with the foamed part 18, the fastening pin 48 may also extend through the foamed part 18 and be fastened to the support frame 38, which rests directly on or against one of the end faces of the foamed part 18.

A support frame 38 made of an electrically insulating material could, of course, also be attached directly to the foamed part 18 in some other way, for example by welding, gluing, soldering or the like.

In the embodiment shown, the stabilization part 40 is of a multi-part and pin-like configuration.

The stabilization part 40 comprises a pin 52 which extends axially through the recess 30 and a counter piece 54 which is fastened to the pin 52 such that the foamed part 18 is clamped between the pin 52 and the counter piece 54.

The pin 52 has a head part 56 that rests against an end face of the foamed part 18.

The pin 52 further comprises a shank 58 which, starting from the head part 56, extends axially through the recess 30 of the foamed part 18 and ends freely.

In the variant illustrated here, the pin 52 comprises electrically insulating material, for example ceramics, at least in the contact area with the foamed part 18.

To this end, the pin 52 may be coated with or consist of the electrically insulating material.

The counter piece 54 is arranged at the free end and thus at the end of the pin 52 opposite the head part 56.

Here, the counter piece 54 is arranged at the front end face 26 and the head part 56 is arranged at the rear end face 27 of the foamed part 18.

However, this is to be understood only as an example. The counter piece 54 may also be arranged at the rear end face 27 and the head part 56 may be arranged at the front end face 26 of the foamed part 18.

The head part 56 and the counter piece 54 each constitute a laterally projecting head of the stabilization part 40, between which the foamed part 18 is clamped, more precisely between the contact surfaces of the head part 56 and of the counter piece 54 on the part 18.

In the variant shown, the counter piece 54 includes a cap 60 and an electrically insulating element 162, here in the form of an insulating ring 62, arranged between the cap 60 and the foamed part 18.

The insulating ring 62 has a through hole 188, the shank 58 being fitted in the through hole 188 and thus being surrounded by the through hole 188 (see FIGS. 8 to 19). The shank 58 protrudes through the through hole 188.

The insulating ring 62 comprises electrically insulating material, for example ceramics, at least in the area of contact with the foamed part 18 and the cap 60.

To this end, the insulating ring 62 may be coated with or consist of the electrically insulating material.

In this case, the cap 60 may be made of an electrically conductive material since the cap 60 and the foamed part 18 are spaced apart from each other by the insulating ring 62, and the foamed part 18 is electrically insulated from the cap 60.

The counter piece 54 may, of course, also be formed in one piece and be coated with or consist of the electrically insulating material.

The cap 60 may, for example, be pushed on the shank 58 with an interference fit and thereby be secured to the pin 52.

Other fastening methods, for example welding, gluing, soldering, screwing on or the like, are also conceivable.

Owing to the clamping of the foamed part 18 between the pin 52 and the counter piece 54, or more precisely between the head part 56 of the pin 52 and the cap 60 of the counter piece 54, the adjacent sections 32, 34 of the foamed part 18 are mechanically coupled to each other, as a result of which the stiffness of the foamed part 18 can be increased and thus the stability of the foamed part 18 can be improved.

Additionally, the stabilization parts 40 can ensure that the sections 32, 34 remain spaced apart from each other and do not contact each other even in the case of movement of the foamed part 18 as caused by the gas flow or by vehicle vibrations, for example.

Furthermore, further components, for example a foamed catalytic converter, may be fastened to the heating device 12 by means of the support frame 38 and the stabilization parts 40.

For this purpose, the further component may, for example, be welded, glued, soldered or the like to the support frame 38 and the head part 56 or the cap 60.

In this way, the stabilization parts 40 have a coupling function in addition to the stabilization function and, accordingly, also constitute coupling parts.

FIGS. 8 to 10 illustrate further variants of the stabilization part 40, which essentially correspond to the variant according to FIGS. 5 to 7. Accordingly, only the differences will be discussed below, and identical and functionally identical parts are provided with the same reference numbers.

In the second variant of the stabilization part 40 according to FIG. 8, the insulating ring 62 of the head part 56 extends axially into the recess 30, thus providing a distance between the shank 58 and the walls 45 of the recess 30, in addition to the distance between the cap 60 and the associated end face.

In addition, a second electrically insulating element 164, here in the form of a second insulating ring 64, is provided, which is substantially the same as the insulating ring 62 and is arranged at the head part 56 to provide a distance between the head part 56 and the associated end face and also between the shank 58 and the walls 45 of the recess 30. The insulating rings 62, 64 have different sections, namely they each have a laterally projecting collar 180, 182 and a sleeve-like extension 184, 186.

Like the first insulating ring 62, the second insulating ring 64 has a through hole 190, with the shank 58 being inserted into, and thus surrounded by and extending through, the through hole 190.

In this case, the pin 52 and the cap 60 may be made of an electrically conductive material because the pin 52 and the cap 60 are spaced apart from the foamed part 18 by the collars 180, 182 and the extensions 184, 186 of the insulating rings 62, 64, and the foamed part 18 is electrically insulated from the pin 52 and the cap 60.

A third variant of the stabilization part 40 according to FIG. 9 is very similar to the first variant according to FIG. 7.

However, the electrical insulation between the pin 52 and the foamed part 18 is not provided by the pin 52 including an electrically insulating coating or being made of an electrically insulating material, but by the electrically insulating element 164, here in the form of an insulating sleeve 66, which extends over the entire potential contact area between the pin 52 and the foamed part 18.

A fourth variant of the stabilization part 40 according to FIG. 10 is very similar to the second variant according to FIG. 8.

Here, however, an elastic compensating element 161 in the form of a spring element 68 (e.g., disk springs) is provided between the head part 56 and the second insulating ring 64 and is biased such that it pushes the head part 56 away from the second insulating ring 64. In this way, the second insulating ring 64 is spring-biased against the foamed part 18 and the first insulating ring 62 is spring-biased against the foamed part 18 via the cap 60.

This allows, for example, any manufacturing-related gaps or distances between the stabilization part 40 and the foamed part 18 to be compensated, as a result of which movements and attendant noises can be eliminated.

The positioning of the spring element 68 between the head part 56 and the second insulating ring 64 is to be understood to be merely exemplary. Provision may, of course, also be made for the spring element 68 to be arranged between the cap 60 and the first insulating ring 62.

It is, of course, also conceivable that the spring element 68 is employed in the first variant according to FIG. 7 or the third variant according to FIG. 9.

Furthermore, it is possible to manufacture the spring element 68 from an electrically insulating material. In this way, the spring element 68 can directly engage an end face of the foamed part 18, thereby eliminating the need for the second insulating ring 64.

A further variant of the stabilization part 40 is shown in FIG. 11. In terms of its technical effect, the stabilization part 40 shown here is very similar to the stabilization part 40 from the variant as shown in FIG. 10. Accordingly, only the differences will be discussed below, and identical and functionally identical parts are provided with the same reference numbers.

Instead of a pin 52 and a counter piece 54, only the spring element 68 is provided here, which extends from one of the end faces through the recess 30 and to the other of the end faces, urging the first insulating ring 62 and the second insulating ring 64 against the foamed part 18.

Rather than one of the insulating rings 62, 64, the insulating sleeve 66, as in the third variant according to FIG. 9, may of course also be used.

Furthermore, the spring element 68 may be manufactured from an electrically insulating material. This allows the spring element 68 to directly engage the end faces 26, 27 of the foamed part 18, thereby eliminating the need for the insulating rings 62, 64.

The variant according to FIG. 12 corresponds to the variant according to FIG. 8, in particular wherein the pin 52 of the stabilization part 40 is made of an austenitic stainless steel and the insulating rings 62, 64 are made of a ceramic material.

The variant according to FIG. 13 essentially corresponds to the variant according to FIG. 10, but the spring element 68 has been replaced by a first elastic compensating element 161, which in FIG. 13 is arranged between the cap 60 and the electrically insulating element 162 as an example. However, the first elastic compensating element 161 may also be arranged at any other location between the cap 60 and the head part 56, but it should be made sure that the flux of force is always directed via the first elastic compensating element 161. In the variant shown, this first elastic compensating element 161 is in the form of an elastic mat 61.

The elastic mat 61 serves to compensate for a possibly unequal expansion due to different coefficients of thermal expansion between the shank 58 and the insulating rings 62, 64 and the foamed part 18. Here, the elastic mat 61 ensures that the clamping force remains approximately constant during any temperature change and that the foamed part is always held but not plastically deformed.

A variant according to FIG. 14 comprises first and second elastic compensating elements 151, 161, here in the form of two elastic mats 51, 61, which replace the known electrically insulating elements 162, 164 from the second embodiment. For this reason, the elastic mats 51, 61 are made to be electrically insulating. The two elastic mats 51, 61 provide a more uniform distribution of the compressive force on the foamed part 18. In addition, as in the variant embodiment according to FIG. 13, different coefficients of expansion are compensated.

The variant according to FIG. 15 essentially corresponds to the variant according to FIG. 8, but additionally comprises a bushing 41, which is embedded in the foamed part 18 between the axial bearing surfaces of the insulating rings 62, 64 contacting the foamed part 18.

The bushing 41 may preferably be made of a material that exhibits a greater resistance to plastic deformation than the foamed part 18. In particular, the bushing 41 may be made of a metallic material. To prevent the two opposing sections 23, 24 from being short-circuited, the bushing may be made slotted, and a plastic material may be introduced in the slots for electrical insulation, for example.

In a variant according to FIG. 16, similar to the variant according to FIG. 8, the foamed part 18 is additionally plastically precompressed between the insulating rings 62, 64. This precompression compresses the material and thereby makes it particularly robust, similar to the variant according to FIG. 15, which includes a bushing 41 in the foamed part 18. Further plastic deformation in operation thus only occurs at an increased clamping force, which is why the coefficients of thermal expansion of the pin 52, the insulating rings 62, 64 and the foamed part 18 may differ more markedly from one another.

Likewise, the contact area between the insulating rings 62, 64 and the foamed part 18 increases, since their collars 180, 182 project at least partly into the foamed part 18. As a result, the foamed part 18 is even better mechanically connected to the stabilization part 40.

The variant according to FIG. 17 uses a spring element 68 as the first elastic compensating element 161. To this end, the spring element 68 is clamped to the shank 58 of the pin 52 and, together with the insulating ring 62, forms the counter piece 54. To prevent the gas flow (see arrow) from additionally loading the spring element 68, the latter is mounted behind the foamed part 18 in the direction of flow. In terms of the technical effect, this embodiment is similar to the variant shown in FIG. 13, but has the advantage of a lower variety of parts, since the spring element 68 combines the function of the cap 60 and of the first elastic compensating element 161.

In the illustrated embodiments, the materials of the stabilization part 40, the electrically insulating elements 162, 164 and the foamed part 18 are matched to one another in terms of their dimensions and, above all, their coefficients of thermal expansion in such a way that, in the case of any temperature change within the operating temperature range from −50° C. to 1100° C., neither the foamed part 18 is plastically deformed nor does a clamping force drop to zero. Therefore, an acceptable clamping force is available at all times, which does not overstress the foamed part 18.

The variant according to FIG. 18 is similar to the variant according to FIG. 12, with the head part 56, the counter piece 54 and the insulating elements 162, 164 formed as insulating rings 62, 64 now having a slightly different shape.

In the present variant according to FIG. 18, the first insulating ring 62 is identical in construction to the second insulating ring 64, which is why only the first insulating ring 62 is described below with reference to FIG. 19.

In FIG. 19, the first insulating ring 62 is depicted separately. Unlike the previously shown variants of the insulating rings 62, according to the sectional view shown, this insulating ring is now provided with a transition surface 194 extending obliquely, i.e. not at right angles, to a front side surface 192 of the insulating ring 62. The transition surface 194 has, for example, a conical shape, which is not to be construed as limiting.

The transition surface 194 is part of the through hole 188, with the through hole 188 increasing in size along its longitudinal direction toward the front side surface 192.

The head part 56 has a conical lower surface 196, which rests on the conical transition surface 194 of the first insulating ring 62 (see FIG. 18).

Likewise, the cap 60 of the counter piece 54 has a conical lower surface 198, which rests on the conical transition surface 194 of the second insulating ring 64.

The through hole 188, which is enlarged at the front side surface 192, allows a shorter length to be selected for the shank 58 of the pin 52, as a result of which differences in the coefficients of expansion of the pin 52, the foamed part 18 and the insulating elements 162, 164 due to their different materials have less effect on the clamping force when the temperature changes.

In other words, the effective length of the shank 58 can be made shorter, as a result of which changes in temperature affect the absolute change in length of the pin 52 to a lesser extent.

1. A heating device for an exhaust system, comprising
an electrically conductive foamed part which is coupled to at least one electrode, is oriented transversely to an exhaust gas stream and through which exhaust gas to be treated can flow axially, and which includes an upstream oriented front end face, a downstream oriented rear end face, an outer circumference, and at least one recess starting from the outer circumference and extending through the electrically conductive foamed part in an axial direction from the upstream oriented front end face to the downstream oriented rear end face, so that the at least one recess produces sections of the electrically conductive foamed part which are opposite each other at a distance and continue into each other, forming a current path as a resistance heating element between the at least one electrode and a further electrically conductive component, to which the electrically conductive foamed part is coupled, and
at least one stabilization part for the electrically conductive foamed part, which at least partially fills the at least one recess and couples the sections mechanically to each other and does not couple them electrically.

2. The heating device according to claim 1, wherein the at least one recess, in an axial view, extends between the sections in a straight line and/or in a curved manner.

3. The heating device according to claim 2, wherein the current path extends in a spiral shape or a meandering shape.

4. The heating device according to claim 1, wherein the electrically conductive foamed part includes a plurality of recesses which extend parallel at least in sections in an axial view.

5. The heating device according to claim 4, wherein neighboring recesses begin at substantially opposite portions of the outer circumference and extend between neighboring recesses that start from the opposite portion.

6. (canceled)

7. (canceled)

8. The heating device according to claim 1, wherein a support frame rests against an outer circumferential surface and/or against at least one of the upstream oriented and downstream orientated end faces.

9. The heating device according to claim 1, wherein the at least one stabilization part is fastened to a support frame and, starting from the support frame, extends in a transverse direction into the at least one recess, and the at least one stabilization part is adapted to a shape of the at least one recess, in particular in that the at least one stabilization part completely fills the at least one recess.

10. The heating device according to claim 9, wherein the at least one recess comprises a plurality of recesses, and wherein the electrically conductive foamed part is molded, foamed, or injected into an intermediate space between the at least one stabilization part and the support frame, or wherein the at least one stabilization part and the support frame are molded, foamed, or injected into the plurality of recesses and around the outer circumference.

11. The heating device according to claim 1, wherein the at least one stabilization part is formed to be pin-like.

12. The heating device according to claim 11, wherein at one of two axial ends the at least one stabilization part has a laterally projecting head part and at the other of the two axial ends the at least one stabilization part has a counter piece, between which the electrically conductive foamed part is clamped.

13. The heating device according to claim 12, wherein a respective electrically insulating element is provided at each of the two axial ends of the at least one stabilization part, wherein the electrically insulating elements rest against the electrically conductive foamed part on opposite sides and the electrically conductive foamed part is clamped between the electrically insulating elements by the at least one stabilization part, wherein a clamping force is adjusted by a distance between the laterally projecting head part and the counter piece, and wherein materials of the at least one stabilization part, the electrically insulating elements, and the electrically conductive foamed part are selected based on their coefficients of thermal expansion such that in case of any temperature change within an operating temperature range of −50° C. to 1100° C., neither the electrically conductive foamed part is plastically deformed nor does the clamping force decrease to zero.

14. The heating device according to claim 13, wherein at least some of the electrically insulating elements include a collar resting on one side of the electrically conductive foamed part and an extension extending into the at least one recess.

15. The heating device according to claim 13, wherein at least one of the electrically insulating elements has a front side surface and a through hole that extends from the front side surface, the through hole increasing in size along a longitudinal direction toward the front side surface, an increase in size of the through hole being formed by a transition surface extending obliquely to the front side surface, and the laterally projecting head part or a cap of the counter piece resting on the transition surface.

16. The heating device according to claim 13, wherein an additional elastic compensating element is arranged and clamped between an electrically insulating element and the contacting head part or counter piece.

17. The heating device according to claim 16, wherein at least one of the respective elastic compensating elements is a spring element or an elastic mat.

18. The heating device according to claim 13, wherein an additional electrically insulating sleeve is arranged between a shank of the at least one stabilization part and the electrically conductive foamed part in the at least one recess and the electrically conductive foamed part is held at a defined distance from the shank by this sleeve.

19. The heating device according to claim 13, wherein the electrically conductive foamed part is reinforced with a bushing, which is embedded in the electrically conductive foamed part, between the two electrically insulating elements in the area of the at least one recess.

20. The heating device according to claim 19, wherein the bushing is made to be slotted and/or comprises both electrically insulating and non-insulating materials.

21. The heating device according to claim 13, wherein in a state not provided with the at least one stabilization part, the electrically conductive foamed part is locally plastically deformed at axial contact surfaces for the two electrically insulating elements to form a depression into which the associated electrically insulating element extends.

22. The heating device according to claim 1, wherein the at least one stabilization part comprises a plurality of stabilization parts that are provided in the at least one recess.

23. An exhaust system comprising an exhaust gas-carrying pipe and the heating device which is seated in the exhaust gas-carrying pipe and through which exhaust gas flows, according to claim 1, wherein a support frame is provided which circumferentially surrounds the electrically conductive foamed part at the outer circumference, and wherein the electrically conductive foamed part is self-supporting in the axial direction in a region laterally of the support frame.
